(19) United States
(12) Patent Application Publication
(10) Pub. No.: US 2023/0383879 A1
(43) Pub. Date: Nov. 30, 2023

(54) DOUBLE SIDED CONNECTOR

(71) Applicant: RB Distribution, Inc., Colmar, PA (US)

(72) Inventors: Austin Sutter Reiss, Philadelphia, PA (US); John Idemudia Okpiaifo, Lansdale, PA (US); Cameron Mitchel Medendorp, Telford, PA (US)

(73) Assignee: RB Distribution, Inc., Colmar, PA (US)

(21) Appl. No.: 17/752,058

(22) Filed: May 24, 2022

(51) Int. Cl. F16L 33/12

(52) U.S. Cl. CPC F16L 33/12

(57) ABSTRACT

The disclosed connector provides at least one female side with a sealing array comprised of first sealing member, a spacer, and a second sealing member that are all aligned to receive one end of an inserted part. A toolless retainer is positioned between the seals and the opening of the female side. The toolless retainer array has at least three appendages that extend outwardly for a distance and fold back inwardly to define three holders for retaining the inserted part. The seals are compressible and the spacer is non-compressible. The preferred connector has two female sides with toolless connectors.

### FIELD OF INVENTION

The invention relates generally to the field of connecting the ends of two fluid containing lines. More particularly, the invention relates to connecting at least one semi-rigid line to another line. Even more particularly, the invention related to connecting two fluid carrying lines with at least one quick connector. Most particularly, the invention related to a double sided quick connector for connecting lines carrying hydraulic fluids.

### BACKGROUND

The known connectors have a male end for connecting a flexible line, like rubber tubing, and a female end for connecting a rigid line, such as metallic transmission fluid lines which had often required additional hardware to accomplish the connection.

A known connector illustrated in FIGS. 1 and 2, as “A,” has a male end “B” that is configured for attachment to flexible tubing and a female end “C” that is configured for attachment to a rigid material. The female connector “C” has an internal channel “D” that includes a retainer “E” for contacting and holding an inserted part. FIG. 3 is a perspective view of the prior art part retainer. As can be seen from FIG. 3, the part retainer “E” has two appendages “F” that extend outwardly from the “G” and bend inwardly to form two retainer pads “H” on either side of the central portion “J” that are opposed to each other.

In view of the above, the art desires a connector with a female connection that provides an improved sealing arrangement, and the art also desires a double sided connector with two female connections.

### SUMMARY

The invention provides a connector with a female end having a sealing array comprised of first sealing member, a spacer, and a second sealing member that are aligned to receive and seal against one end of an inserted part. The part retainer, positioned between the sealing array and the female end opening in alignment, flexes outward to receive the part and flexes inward to retain the part. The part retainer has at least three independent appendages that extend away from the base for a predetermined length and are folded back toward the base to define the independent holders. A preferred connector has two female connections with the described construction.

### BRIEF DESCRIPTION OF THE DRAWINGS

FIG. 1 illustrates a side view of a known prior art connector;

FIG. 2 illustrates a perspective view of the connector in FIG. 1;

FIG. 3 illustrates the part retainer in connector in FIG. 1;

FIG. 4 is a perspective view of a preferred connector according to the present invention;

FIG. 5 is an exploded view of the connection in FIG. 4;

FIG. 6 is a section view showing the preferred connector in an assembled condition prior to forming the female ends inward;

FIG. 7 is a section view showing the connector of FIG. 6 after forming of the female ends;

FIG. 8 illustrates axial alignment of the parts prior to insertion in the connector;

FIG. 9 is a section view illustrating the final assembly;

FIG. 10 is a section view illustrating the connector having different size female ends assembled with two parts having different diameters;

FIG. 11 illustrates an alternative configuration of the part retainer;

FIG. 12 is a perspective view of another alternative preferred retainer assembly;

FIG. 13 is a perspective view of a preferred part retainer;

FIG. 14 is a perspective view of an alternative part retainer; and,

FIGS. 15-17 illustrate optional protective boots for the female end.

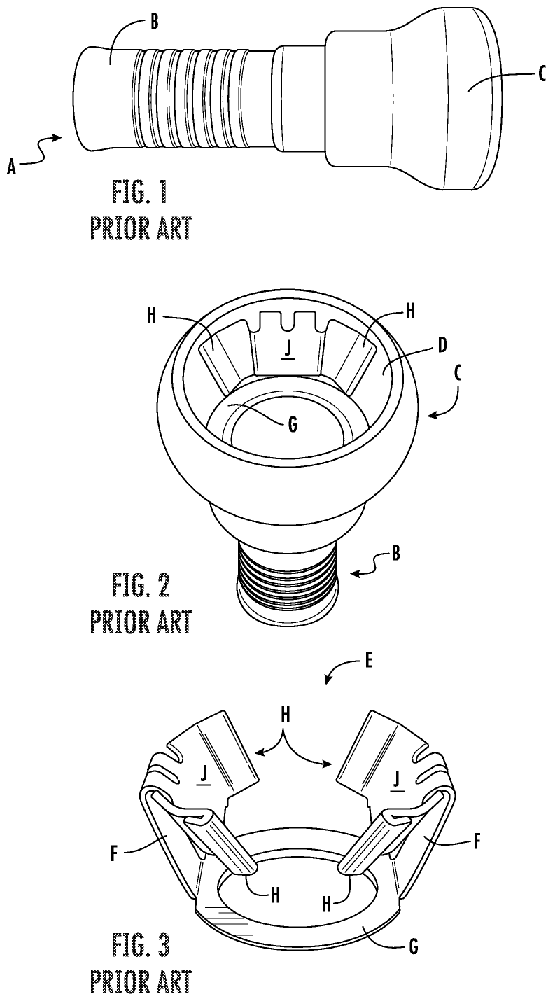

### DETAILED DESCRIPTION OF THE PREFERRED EMBODIMENTS

The preferred embodiments will be described in detail with reference to FIGS. 4-17.

The connector 2 illustrated in FIG. 4 has a central or intermediate portion 10 that extends between the two female portions 12 that have open ends 14. Each of the female portions is a toolless connector that includes a connecting assembly that grips and seals against an inserted line without the need for a tool to complete the connection. While the preferred embodiment has two toolless connectors, a single toolless connector may be paired with a connector that requires a tool to complete the connection. As will be discussed later in connection with an alternative embodiment, the connector portions 12 may have different sizes with the internal and external components of the different connectors remaining the same except for the scaling.

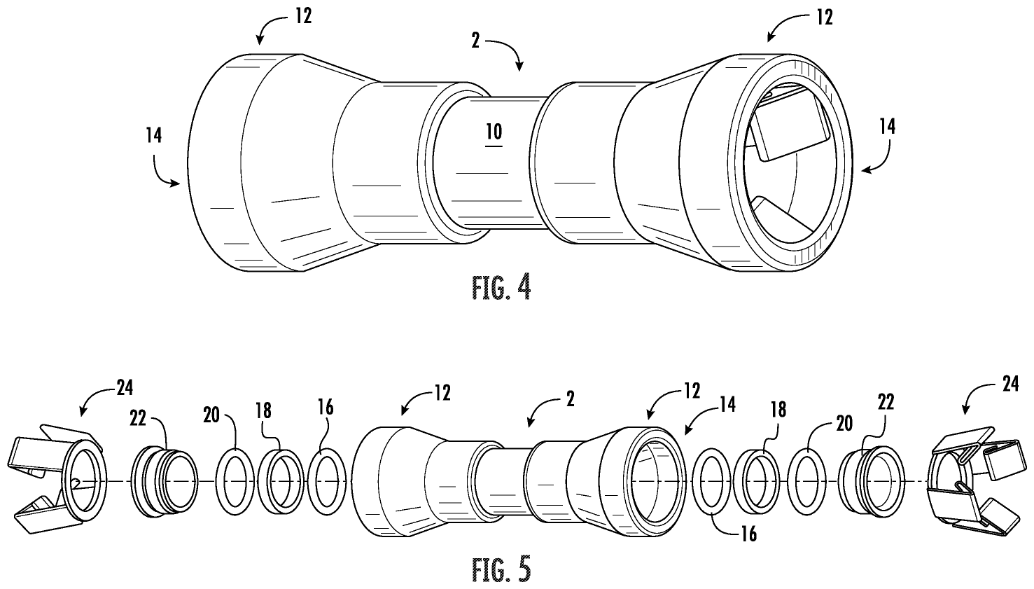

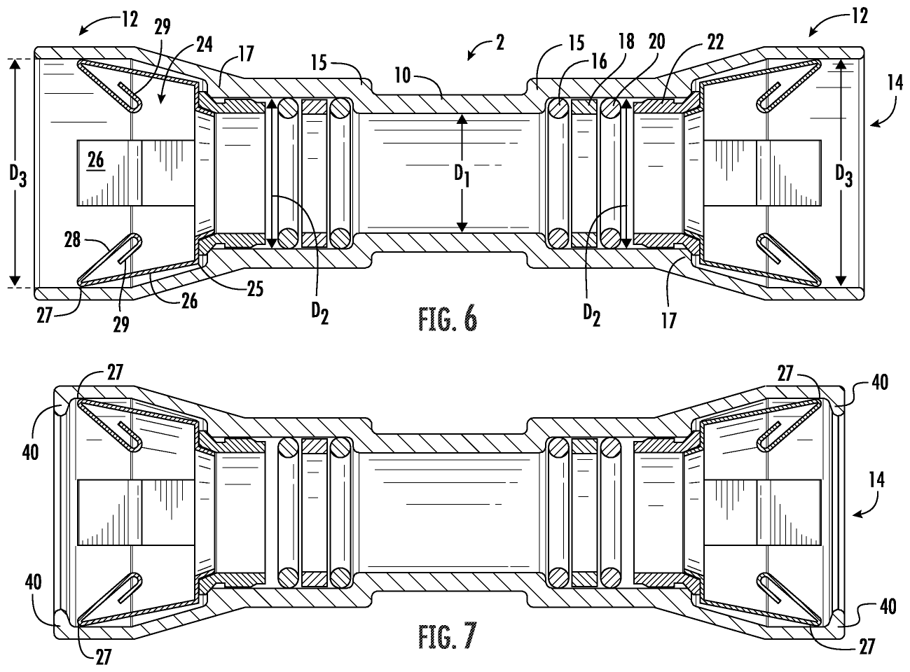

With reference to FIGS. 5-7, the internal components in each connector portion will be described. The components include a first “O” ring 16, a spacer 18, a second “O” ring 20, a cap 22 and retainer assembly 24. With reference to FIGS. 6 and 7, it can be seen that the first “O” ring 16 is blocked by the ridge or lip 15, which results from the different in diameters between D1 and D2, and the cap 22 rest against the ridge or lip 17, which results from the different in diameters between D2 and D3. This arrangement forms a captive area within D2 with a gap between the second “O” ring 20 and the cap 22 which permits expansion of the “O” rings 16 and 20 when a line is inserted and makes it possible to extract the line if that becomes desirable or necessary. With reference to FIG. 7, a retainer 24 is inserted behind the cap 22 and the open end 14 is mechanically swaged to form the lip 40 over the elbows 26 of the retainer appendages. The mechanical swaging to form lip 40 may take place before or after the internal components are assembled inside the connector.

The retainer 24 has a circular base 25 that has a depend ring which, in this embodiment, fits within the cap 22 and has the same interior diameter as cap 22. The circular base 25 is supported on the upper surface of cap 22. This arrangement is believed to create stability and keep the components axially aligned during and insertion.

The appendages 26 extend outwardly from the base 25 to an outer diameter substantially equal to D3. The appendages 26 bend at the elbow 27 to define the inwardly and downwardly portion 28 that has a free end 29 that bend s back toward the elbow 27. With reference to FIG. 7 it can be seen that the ends 14 are swaged to form the lip 40 above elbow 27 and secure the retainer 24.

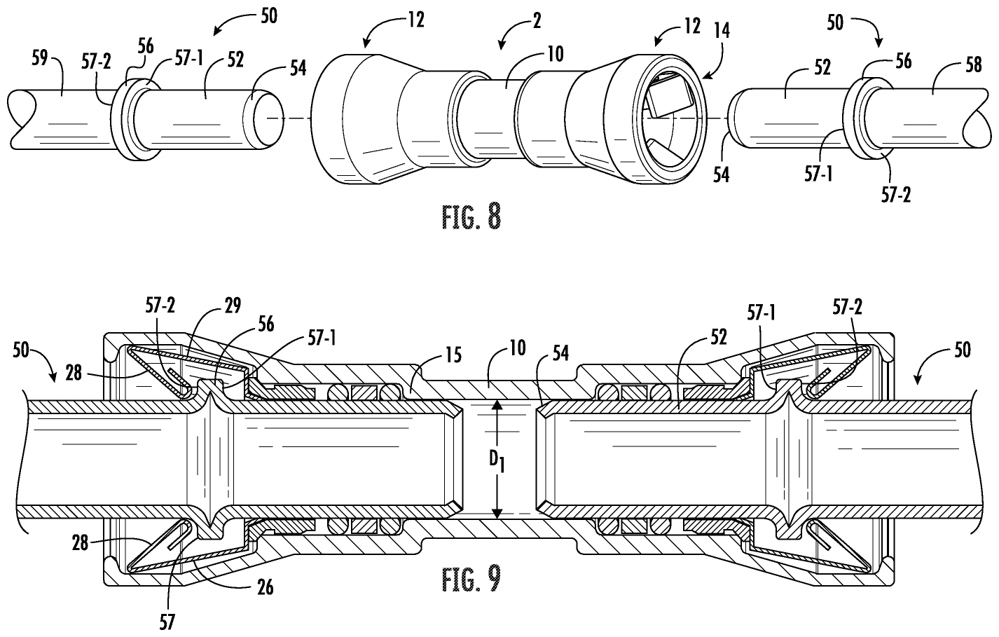

With reference to FIGS. 8 and 9, use of the female connector will be demonstrated in connection with a semi-metallic fluid line. The double sided connector 2 is as previously described. Each line 50 is preformed to have a preformed collar 56, having the abutment surfaces 57-1 and 57-2, which separates a lead end 52 and a trailing length 58. The lead end 52 preferably has a taper 54 to assist in insertion of the line 50. The lead end 52 and the connector 2 are sized so the taper 54 extends into the central portion 10 beyond the lip 15. With reference to FIG. 9, insertion of the line 50 brings the collar 56 into contact with the downward portion 28 and flexes portion 28 toward the appendage 26. After the collar 56 passes the downward portion 28, the downward portion 28 spring back and the free end 29 abuts the abutment surface 57 to retain the line 50 in connector 2.

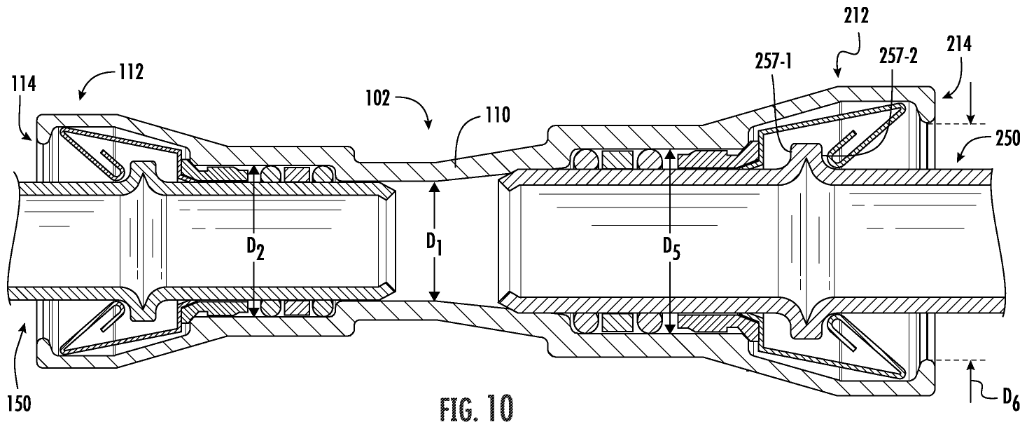

With reference to FIG. 10, the connection between different size lines is illustrate. Connector 102 has one female portion 112 that is as previously described and one female portion 212 with a larger open end 214 to receive a large line 250. As noted earlier, the internal structure of the female portion is the same except for size. The central portion 110 differs in that it will have a taper that to accommodate the different size lines. The axial length of the central portion 110 will be selected to have a smooth flow without excess turbulence in the central portions 110.

As can be seen by reference to FIGS. 9 and 10, D1 of the intermediate portion 10 is selected to complement the outer diameter of the tubes 50 without hindering the flow path of fluid between the tubes 50, D1′ of the intermediate portion 110 is selected to complement the respective outer diameter of the tubes 150 and 250 without hindering the fluid flow path.

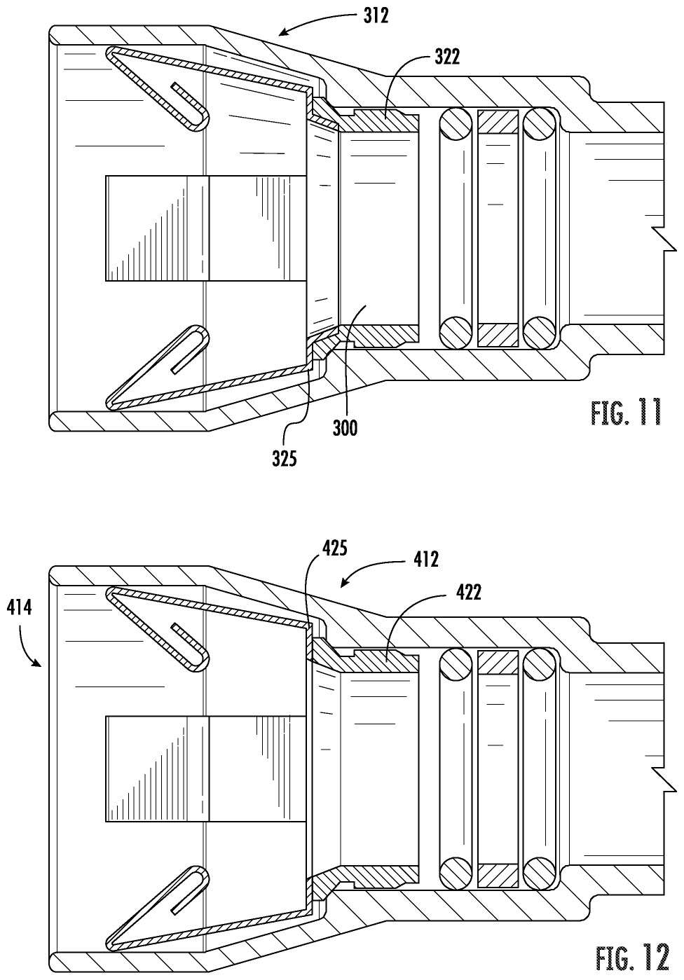

With reference to FIG. 11, an alternative position of the base 325 with respect to the cap 322 is illustrated. In this embodiment, the cap 322 has a recess that forms a shelf or ledge 300 on which the dependent ring of base 325 sits while the base 325 is supported on the cap 322. Like the prior embodiment, this arrangement is believed to create stability and keep the components axially aligned during and insertion.

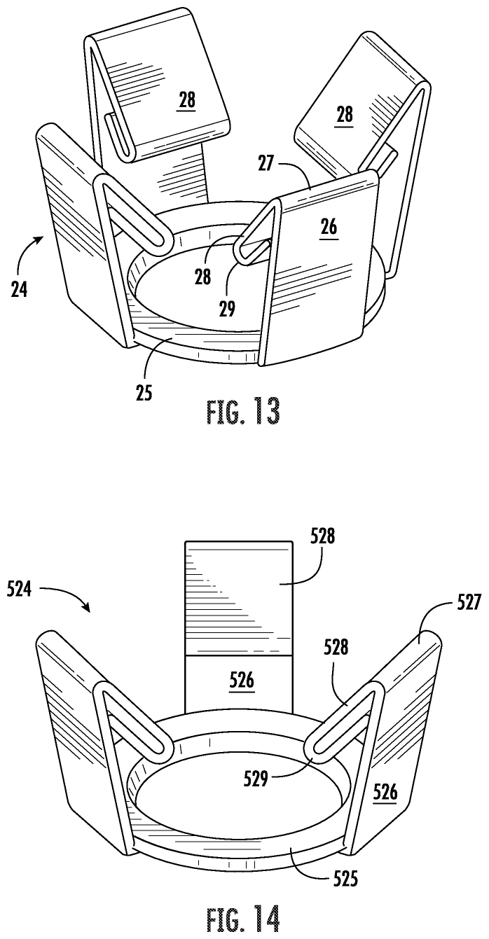

With reference to FIG. 12, another alternative position of the base 425 with respect to the cap 422 is illustrated. In this embodiment, the base 425 rests directly on the cap 422 and there is no dependent ring so the retainer 24 is guided by the inserted line, and the base 425 is supported on the cap 422. This arrangement is believed to create stability by maintaining the retainer axially aligned with the line during and insertion through the action of the appendages.

FIGS. 13 and 14 illustrate two preferred configurations for the retainer. FIG. 13 illustrated the previously described retainer 24 with four independent appendages. FIG. 14 illustrated another preferred retainer 524 with three independent appendages 526. Each of the appendages 526 are configured like the prior embodiment. The advantage to these embodiments is the equidistant spacing of the appendages so there are at least three contact points while the line is being inserted and at least three abutments after the line is inserted.

In a preferred embodiment the O-rings 16 and 20 are made of Hydrogenated Nitrile Butadiene Rubber (HNBR) having an initial hardness of 70+/−5 International Rubber Hardness Degree (IRHD). The spacer 18 is made of a harder material than the O-rings, such PA366 Plastic or brass. This arrangement of materials has been determined to be sufficiently stable to seal the O-rings 16 and 20 against the outer diameter of the lines and retain a gap beneath the cap 22.

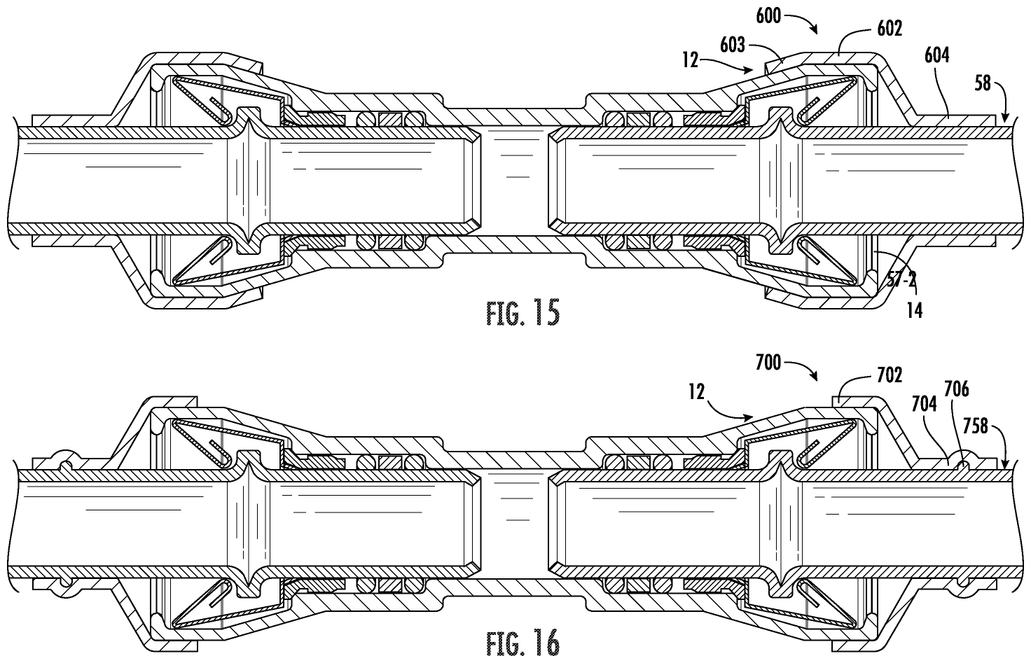

FIG. 15 illustrates a boot for the open end of the connector to protect against dirt and road debris. In this embodiment, the boot 600 has a first portion 602 that is stretched over the larger outer diameter of the connector 12, a second portion 603 that is stretched over the tapered portion of connector 12, and a smaller diameter portion 604 that is stretched over the trailing length 58 of the line 50.

FIG. 16 illustrates another boot for the open end of the connector to protect against dirt and road debris. In this embodiment, the boot 700 has a large diameter portion 702 that is stretched over the connector 12 and a smaller diameter 704 that is stretched over the trailing length 758 and secured by a collar 706. The collar 706 may be formed in the trailing length or molded in the boot 700.

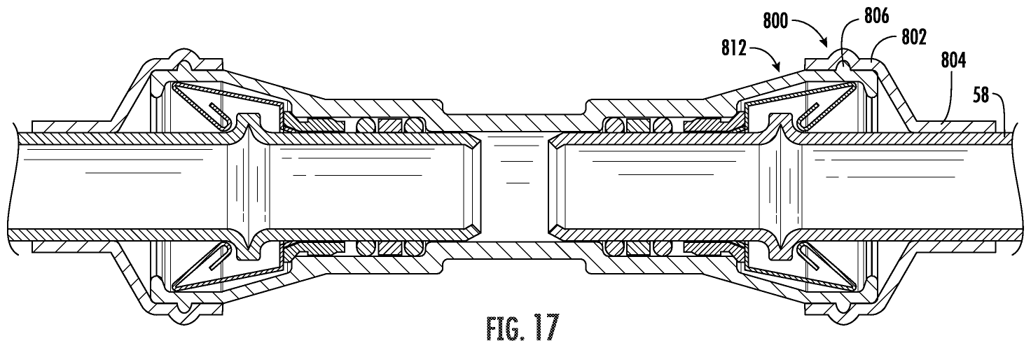

FIG. 17 illustrates another boot for the open end of the connector to protect against dirt and road debris. In this embodiment, the boot 800 has a large diameter portion 802 that is stretched over the connector 812 and a smaller diameter 704 that is stretched over the trailing length 58. The large diameter portion 802 is and secured by a collar 806. The collar 806 may be formed in the connector 812 length or molded in the boot 800.

1. A double sided connector comprising:
a tubular housing having two connector portions joined together with an intermediate portion that has an inner diameter D1 selected to complement a flow path between the two connector portions;
at least one of the two connector portions is a toolless connector having:
a first connecting portion with an inner diameter D2 that is adjacent to and greater than the intermediate portion's inner diameter D1 and a second connecting portion at an open end of the toolless connector with an inner diameter D3 that is greater than the first connecting portion inner diameter;
a first seal with an outer diameter that complements the first connecting portion inner diameter and an inner diameter that is no greater than the intermediate portion inner diameter;
a non-compressible spacer with an outer diameter that complements the first connecting portion inner diameter and an inner diameter that is no greater than the intermediate portion's inner diameter is positioned with a first side adjacent to the first seal;
a second seal with an outer diameter that complements the first connecting portion's inner diameter and an inner diameter that is no greater than the intermediate portion inner diameter is positioned adjacent to a second side of the non-compressible spacer;
a cap with a first portion having an inner diameter that is substantially equal to the intermediate portion inner diameter D1 and an outer diameter less than the first connecting portion inner diameter D2 that is positioned after and spaced from the second seal to define a gap between the cap and the second seal and a second portion, and a second portion that has an outer diameter greater than first connecting portion inner diameter D2; and,
a toolless retainer is positioned between the cap and an open end of the tubular housing, the toolless retainer has; a base and at least three independent appendages, each of the at least three independent appendages extends radially from the base toward the open end for a predetermined length where each appendage has a maximum outer diameter equal to D3 and is folded inwardly from the open end to define a toolless retainer for an inserted item; whereby an inserted item is retained in the toolless connector entirely by the toolless retainer.

2. The double sided connector of claim 1, wherein the toolless retainer has at least four independent appendages.

3. The double sided connector of claim 1, wherein the two connector portions have toolless connectors.

4. The double sided connector of claim 3, wherein each toolless retainer has at least four independent appendages.

5. The double sided connector of claim 1, wherein the two connector portions are dimensioned to retain inserted items of different sizes.

6. The double sided connector of claim 5, wherein the two connector portions have toolless connectors that are dimensioned to retain inserted items of different sizes.

7. A connector comprising:
an elongated housing with at least one female connector portion that is joined with a second connector portion, the female connector portion has a first open section with a first diameter and a second open section with a second diameter that is less than the first diameter;
the first open section of the at least one female connector portion encloses a toolless retainer with at least three flexible appendages that extend outwardly from a base for a predetermined length and fold back toward the base for a predetermined length to define the at least three flexible toolless holders and establish an interior diameter that is less than the second diameter;
the second open section includes a first seal and a second seal dimensioned to abut the second diameter in the second section and inner diameters that are selected to seal against and exterior portion of a predetermined part inserted in the female connector portion, and a spacer, positioned between the first seal and the second seal, is non-compressible and has an inner diameter that is at least equal to the exterior diameter of the predetermined part; and,
a cap with an inner diameter that is substantially equal to the intermediate portion inner diameter is positioned after and spaced from the second seal to define a gap between the cap and the second seal;
whereby the at least three flexible appendages flex outwardly upon insertion of a predetermined parts and press against a collar on an exterior portion of an inserted part and an inserted part is retained in the female connector portion entirely by the at least three flexible appendages pressed against a collar on an exterior portion of an inserted part.

8. (canceled)

9. The connector of claim 7, wherein the at least three flexible appendages flex independently from each other.

10. The connector of claim 7, wherein there are at least four flexible appendages.

11. The connector of claim 7, wherein the second portion is a toolless female connector.

12. A toolless fluid line connector comprising:
a first portion and a second portion that are joined by middle portion, at least one of the first portion or the second portion is a female connector having a first open section with a first diameter and a second open section with a second diameter that is less than the first diameter, and the middle portion has a diameter that is less than the second diameter and at least equal to the outer diameter of a determined part;
the first open section of the female connector includes a part retainer with at least three flexible appendages that extend outwardly from a base of the part retainer for a predetermined length and fold back toward the base for a predetermined length to define the at least three flexible part holders and establish an interior diameter that is less than the second diameter;
the second open section of the female connector includes a first seal and a second seal that have outer diameters that abut the second diameter in the second section and inner diameters that are selected to seal against an exterior of a portion of a predetermined part to be insert in the female connector, and a spacer, positioned between the first seal and the second seal, is non-compressible and has an inner diameter that is at least equal to the exterior diameter of a predetermined part; and,
the part retainer rest on a cap with an inner diameter that is substantially equal to the intermediate portion inner diameter that is positioned after and spaced from the second seal;
whereby the at least three flexible appendages flex outwardly from an insertion force associated with a predetermined part and flex inwardly to press against an exterior portion of an inserted predetermined part after the predetermined part is inserted and the at least three flexible appendages flex inwardly as the sole retainer for the predetermined part.

13. The fluid line connector of claim 12, wherein the first portion and the second portion both have female connectors.

14. (canceled)

15. (canceled)

16. A kit for toollessly connecting transmission fluid lines, the kit comprising:
a line having a predetermined outer diameter, a lead end, a trailing length, and, a circumferential collar on the outer diameter that separates the lead end from the trailing length, and,
a toolless connector having:
a first portion and a second portion that are joined by middle portion, at least one of the first portion or the second portion is a female connector having a first open section with a first diameter and a second open section with a second diameter that is less than the first diameter, and the middle portion has a diameter that is less than the second diameter and at least equal to the outer diameter of the line;
the first open section of the female connector includes a line retainer with at least three flexible appendages that extend outwardly from a base of the line retainer for a predetermined length and fold back toward the base for a predetermined length to define the at least three flexible line holders and establish an interior diameter that is less than the second diameter;
the second open section of the female connector includes a first seal and a second seal that have outer diameters that abut the second diameter in the second section and inner diameters that are selected to seal against the outer diameter of the line to be insert in the female connector, and a spacer, positioned between the first seal and the second seal, that has an inner diameter that is at least equal to the outer diameter of the line; and,
the line retainer rest on a cap with an inner diameter that is substantially equal to the intermediate portion inner diameter that is positioned after and spaced from the second seal;
whereby the at least three flexible appendages flex outwardly upon contact with the circumferential collar of an inserted line and spring inwardly upon passing of the circumferential collar and abut the circumferential collar of the inserted line as the sole retainer for the inserted line and the cap stabilizes the line retainer during insertion of a line.

17. The kit of claim 16, wherein the first seal and the second seal are comprised of a compressible material and the spacer is comprised of a non-compressible material.

18. The kit of claim 16, wherein one of the first portion and the second portion is a male connector.

19. (canceled)

20. (canceled)
